(19) United States
(12) Patent Application Publication
(10) Pub. No.: US 2024/0251822 A1
(43) Pub. Date: Aug. 1, 2024

(54) MEAT-LIKE PROTEIN COMPOSITION, METHOD FOR PRODUCING THE SAME, MEAT-LIKE FOOD PRODUCT INCLUDING THE SAME, ADDITIVE COMPOSITION, AND USE THEREOF

(71) Applicant: NAGATA SANGYO CO., LTD., Shiso-shi, Hyogo (JP)

(72) Inventor: Kenji TATSUNO, Shiso-shi (JP)

(21) Appl. No.: 18/564,707

(22) PCT Filed: May 31, 2022
(86) PCT No.: PCT/JP2022/022188

§ 371 Date: Nov. 28, 2023

(30) Foreign Application Priority Data
Jun. 1, 2021 (JP) 2021-092353

(51) Int. Cl. A23J 3/18; A23J 3/22; A23L 33/21

(52) U.S. Cl. CPC A23J 3/18; A23J 3/227; A23L 33/21

(57) ABSTRACT

The present invention provides a meat-like protein composition including a gluten, and 0.2 to 3 parts by mass of a dietary fiber derived from wheat grain and 0.08 to 0.7 parts by mass of a protein, other than the gluten, derived from wheat grain, with respect to 100 parts by mass of the gluten, wherein the meat-like protein composition has a water absorption capacity of 300 to 400% of the dry mass.

### FIELD

The present invention relates to a meat-like protein composition using gluten as the main material, having a meat-like fibrous texture, and being capable of feeling a texture of natural meat (farm animal flesh) when chewed; a method for producing the same; as well as a meat-like food product (fake-meat food product) including the meat-like protein composition; an additive composition; and use of the composition.

### BACKGROUND

In recent years, meat-free plant-based meat alternatives have been attracting attention against a backdrop of growing health consciousness and environmental issues, and demand for food products containing plant-based protein into which plant-based proteins such as soy protein is processed has been increasing. Among such food products, processed foods containing mincemeat, such as hamburger patties and meat balls, have been widely consumed. These food products are processed by mixing soy protein, wheat protein, konjak, okara or the like instead of meat, so that the texture of meat is not impaired as much as possible.

The plant-based-protein-containing food product is usually processed into a fibrous structure using a twin-screw extruder in order to impart a texture similar to meat as a meat substitute food product (e.g., Japanese Patent Application KOKAI No. Sho 64(1989)-023855: Patent Literature 1). However, the granular dried soy proteins processed by this method tends to lack elasticity and juiciness, unlike meat. In addition, the plant-based proteins derived from soybeans have a peculiar flavor, known as bean odor or green grass odor, which is an impediment to their utilization. This flavor is due to the fact that lipoxygenase, which is an enzyme that induces bean odor, oxidizes oil and fat components to produce n-hexanal. For this reason, the plant-based proteins are easy to be commercialized as food products with rich seasonings and flavors due to their masking effect, but difficult to be applied to food products with light seasonings and flavors, such as Japanese food. Therefore, under the present circumstances, the number of items of plant-based-protein-containing food product still has not expanded.

As a method for providing hamburger patty-like food product using a plant-based protein, methods for improving texture in place of mincemeat have been proposed, such as a method in which a structured plant-based protein material contains a sugar alcohol (e.g., International Publication No. WO2012/132917: Patent Literature 2), and a method in which a material obtained by mixing a granular soy protein, an isolated soy protein and wheat flour is processed by an extruder, and cut pieces of the structured protein are mixed and molded, and then irradiated with microwaves to bind into a meat substitute (for example, Japanese Patent Application. KOKAI Publication No. 2008-061592: Patent Literature 3). However, these techniques still leave room for improvement in terms of texture and simplicity of the production method, and in particular, food products made with soy protein lack elasticity and are far from having meat-like texture.

On the other hand, granular wheat protein has been proposed as a meat-like protein raw material. In its manufacturing method, unlike with soy protein, a reducing agent, salts, starch, or the like is added to raw gluten to partially destroy the network structure of the gluten for granulation, and then the structure is fixed by heating with hot water or the like. However, such a meat-like protein raw material, once dried, is difficult to reconstitute with water and has drawbacks such as a rubbery texture far from that of meat and a peculiar gluten odor; thus, it is not essentially used with the expectation of a meat-like structure.

In addition, products using granular wheat protein, which are currently in practical use, are distributed and used in a frozen state, and require a freezing step, a thawing step, and facility for keeping such as a freezer during the freezing and thawing steps, and thus have drawbacks in terms of storage and workability (e.g., Masahiko Terashima, “New Protein Material,” Journal of Home Economics of Japan, 1990, Vol. 41, No. 2, p. 157-163: Non-Patent Literature 1).

Technology for fibrous reconstituted food products using wheat protein or the like has also been proposed (Japanese Patent KOKAI No. Sho 54(1979)-122762: Patent Literature 4). However, in addition to wheat protein, a different kind of protein raw material such as soy protein, and acidic sodium sulfite for relaxing high molecular weight polysaccharides or proteins are essential, and a fibrous structure cannot be obtained with wheat protein alone, and a plurality of steps such as a stretching step are required, and thus there is room for improvement in manufacturing.

In addition, a method for producing a meat-like food product using a heat and pressure extruder has been proposed (Japanese Patent Application. KOKAI Publication No. Sho 60(1985)-203146: Patent Literature 5). However, in order to store the meat-like food product in a refrigerated or a retorted form for a long period of time, it is necessary to use starch such as wheat starch or a wheat starch hydrolysate in order to suppress syneresis during storage, and there is room for improvement for the long-term storage.

### CITATION LIST

### Patent Literature

[Patent Literature 1] Japanese Patent Application KOKAI Publication No. Sho 64(1989)-023855
[Patent Literature 2] International Publication No. WO2012/132917
[Patent Literature 3] Japanese Patent Application KOKAI Publication No. 2008-061592
[Patent Literature 4] Japanese Patent Application KOKAI Publication No. Sho 54(1979)-122762
[Patent Literature 5] Japanese Patent Application KOKAI Publication No. Sho 60(1985)-203146

### Non-Patent Literature

[Non-Patent Literature 1] Masahiko Terashima, “New Protein Material,” Journal of Home Economics of Japan, 1990, Vol. 41, No. 2, p. 157-163

### SUMMARY OF INVENTION

### Technical Problem

The plant-based protein materials and the production methods therefor as described in Patent Literatures 1 to 5 and Non-Patent Literature 1 above leave room for improvement in texture, flavor, ease of production, storage stability, and others.

Therefore, an object of the present invention is to provide a meat-like protein composition using gluten as the main material, having a meat-like fibrous texture, and being capable of feeling a texture of natural meat when chewed; a method for producing the same; and a meat-like food product including the meat-like protein composition; as well as an additive composition; and the composition.

### Solution to Problem

The inventor of the present invention, after conducting intensive research to solve the above problem, has found that adding and mixing a gluten with specific amounts of dietary fiber derived from wheat grain and a protein, other than the gluten, derived from wheat grain can produce a meat-like protein composition having a meat-like fibrous texture, feeling a texture of natural meat when chewed, being juicy and excellently reconstituted after rehydration, and having a low plant protein odor, good flavor, and an excellent ease of seasoning that is, a meat-like protein composition that closely mimics natural meat, thus arriving at the present invention.

Thus, according to the present invention, there is provided a meat-like protein composition including: gluten; and 0.2 to 3 parts by mass of a dietary fiber derived from wheat grain and 0.08 to 0.7 parts by mass, of a protein derived from wheat grain other than the gluten, with respect to 100 parts by mass of the gluten, and having a water absorption capacity of 300 to 400% by mass of the dry mass.

In addition, according to the present invention, there is provided a method for producing a meat-like protein composition, the method including a step of mixing a gluten with 0.2 to 3 parts by mass of a dietary fiber derived from wheat grain and 0.08 to 0.7 parts by mass of a protein derived from wheat grain other than the gluten, with respect to 100 parts by mass of the gluten.

Further, according to the present invention, there is provided a meat-like food product including the above-described meat-like protein composition.

In addition, according to the present invention, there is provided an additive including a dietary fiber derived from wheat grain and a protein derived from wheat grain other than the gluten at a mass ratio of 0.2 to 3:0.08 to 0.7, for production of a meat-like protein composition including gluten.

Further, according to the present invention, there is provided use of a composition including a dietary fiber derived from wheat grain and a protein derived from wheat grain other than the gluten at a mass ratio of 0.2 to 3:0.08 to 0.7, for production of a meat-like protein composition including gluten.

### Advantageous Effect of Invention

According to the present invention, it is possible to provide a meat-like protein composition using gluten as the main material, having a meat-like fibrous texture, and being capable of feeling a texture of natural meat when chewed, a method for producing the same, a meat-like food product including the meat-like protein composition, as well as an additive composition, and use of the composition.

The meat-like protein composition of the present invention has less flavor peculiar to plant proteins, is excellent in characteristics such as hardness, elasticity, ease of biting off, and juiciness, and can evenly absorbs the taste of a liquid food product, or the like, cooked therewith to prepare a good, flavored food product. In addition, the method for producing the meat-like protein composition is simple without requiring a special apparatus or a complicated process, and is useful in the food production industry and the food service industry. The additive for use in the production method and the use of a composition including the additive are also useful in the food production industry and the food service industry.

The meat-like protein composition of the present invention can also be used as a material for a meat-like food product (processed food) including the meat-like protein composition.

Although the mechanism for obtaining the meat-like protein composition of the present invention is not clear, it might be deduced that the dietary fiber derived from wheat grain and the protein derived from wheat grain other than gluten interact with glutenin and gliadin, which are main components of gluten, to form fine fibers in gluten so that they are structured to provide the meat-like hardness, elasticity, and ease of biting off.

In addition, the meat-like protein composition, additive composition, and the use of the composition of the present invention further exert the above-mentioned excellent advantageous effect when at least one of the following requirements is satisfied.
(1) The protein is at least one selected from the group consisting of gliadin, glutenin, albumin and globulin, all of which are derived from wheat.
(2) The gluten is wheat gluten.
(3) The dietary fiber and the protein are derived from a main product or a by-product of a process for producing wheat protein or wheat flour starch.
(4) The dietary fiber and the protein are derived from an “aka-kasu” residue, a “shiro-kasu” residue, or wheat flour starch.
(5) The meat-like protein composition has a porous structure with a rugged surface.

In addition, the method for producing the meat-like protein composition of the present invention further exerts the above-mentioned excellent advantageous effect when the following requirement is satisfied.
(6) The gluten is mixed with an “aka-kasu” residue, a “shiro-kasu” residue, or wheat flour starch.

### BRIEF DESCRIPTION OF THE DRAWINGS

FIG. 1 is an optical photomicrograph (20×) showing a surface appearance of a meat-like protein composition obtained in Example 1.

FIG. 2 is an optical photomicrograph (20×) showing a surface appearance of a meat-like protein composition obtained in Example 2.

FIG. 3 is an optical photomicrograph (20×) showing a surface appearance of a meat-like protein composition obtained in Comparative Example 1.

FIG. 4 is an optical photomicrograph (20×) showing a surface appearance of a meat-like protein composition obtained in Comparative Example 3.

FIG. 5 is an optical photomicrograph (20×) showing a surface appearance of a meat-like protein composition obtained in Example 6.

FIG. 6 is an optical photomicrograph (20×) showing a surface appearance of a meat-like protein composition obtained in Example 7.

FIG. 7 is an optical photomicrograph (20×) showing a surface appearance of a meat-like protein composition obtained in Comparative Example 11.

### DESCRIPTION OF EMBODIMENTS

### [Meat-Like Protein Composition]

A meat-like protein composition of the present invention is characterized by including: a gluten; and 0.2 to 3 parts by mass of a dietary fiber derived from wheat grain and 0.08 to 0.7 parts by mass of a protein derived from wheat grain other than the gluten, with respect to 100 parts by mass of the gluten, and having a water absorption capacity of 300 to 400% of the dry mass.

Hereinafter, components and physical properties of the meat-like protein composition of the present invention, a method for producing the meat-like protein composition, and a meat-like food product including the meat-like protein composition, an additive composition, and use of the composition will be described.

### [Gluten]

Gluten, which is the main component of the meat-like protein composition of the present invention, is a gum-like viscoelastic material having a three-dimensional network structure (network) formed by hydration and interaction of glutelin-type proteins and prolamin-type proteins of seed proteins included in grains.

Glutelin-type proteins and prolamin-type proteins are included in wheat, barley, rye, oats, and the like, and glutens obtained therefrom can be used in the present invention.

Among these, wheat gluten derived from wheat is preferred because wheat gluten is advantageous for the production of gluten due to the fact that glutenin as a glutelin-type protein and gliadin as a prolamin-type protein account for about 80% by mass of proteins included in the aleurone layer and endosperm of wheat grain, wheat gluten is easily available due to the established industrial production technology, and because wheat gluten produces an excellent advantageous effect for the meat-like protein composition.

Gluten is obtainable, for example, by kneading wheat flour, barley flour, rye flour, or oat flour with added water to obtain dough, and washing away starch and water-soluble components with a large amount of water.

Examples of gluten obtained industrially include: wheat protein obtained by a known method such as a flash drying method, a spray drying method, a drum drying method, a freeze-drying method, or a vacuum drying method; and gluten in a wet form (raw gluten) obtained by a known method such as the Martin process, the batter process, the hydro-cyclone process, the Alfa-Laval method, or the Tricanter method are mentioned. The Martin process and the batter process are recognized as the most common production methods for the production of wheat gluten.

In addition, gluten in a dry form (powdered gluten) can be obtained by drying and pulverizing raw gluten by a known method.

[Dietary Fiber and Protein Other than Gluten Derived from Wheat Grain]

The protein derived from wheat grain is preferably at least one selected from the group consisting of gliadin, glutenin, albumin and globulin that are derived from wheat.

Dietary fibers and proteins derived from wheat grain are contained in liquids discharged in producing wheat protein or wheat flour starch from wheat flour used as a raw material, such as crude starch milk, and thus the dietary fibers and/or the proteins in such discharged liquids can be used. The dietary fiber and protein other than gluten derived from wheat grain are preferably derived from the endosperm of wheat grain.

Since these discharged liquids are usually discarded, recovering and utilizing them brings about advantages of efficient utilization of the resources and the cost reduction, which is preferable. The matters recovered are referred to as by-products from a process for producing wheat protein or flour starch.

As used herein, the term “wheat flour starch” refers to starch that is produced from wheat flour as a raw material, and may contain a contaminant such as dietary fiber and/or protein derived from wheat flour in addition to starch components (a mixture of amylose and amylopectin). There are product grades of wheat flour starch that contain different amounts of contaminant depending on their degree of refinement, and there is also a grade of wheat flour starch that does not contain dietary fiber. Therefore, in the present invention, wheat flour starch containing both of a dietary fiber and a protein at a specific ratio can be used as the dietary fiber and protein derived from wheat grain.

Note that wheat flour starch is preferable because it has an advantage such as its established industrial production technology and easy availability.

At present, wheat protein and wheat flour starch are typically produced by a method that is according to the Martin process and includes the following steps of:
(1) adding to wheat flour, approximately the same mass of water to make dough;
(2) rinsing the dough in a rinsing machine with about 10 volumes of water to separate crude starch milk and gluten in a wet form (raw gluten), as wheat protein, which is optionally dried to obtain gluten in dry form (powdered gluten);
(3) sieving the obtained crude starch milk to remove, for example, an aka-kasu liquid including an insoluble residue (referred to as aka-kasu residue);
(4) performing centrifugal separation with a nozzle separator, a screw decanter, or the like to separate a starch milk and an insoluble residue (referred to as shiro-kasu residue), wherein the separation is performed according to a starch grade of interest so that the starch milk is obtained with different dietary fiber and protein contents depending on the grade;
(6) dehydrating the obtained starch milk by centrifugal separation, filtering, or the like to obtain a raw cake, wherein the raw cake is repeatedly rinsed, followed by filtration, depending on product grade of interest; and
(7) drying the obtained raw cake with an airflow dryer or the like to obtain wheat flour starch.

In the discharged liquids generated in the above-mentioned production process, not only insoluble wheat starch is present in a dispersed and suspended state, but also soluble polysaccharides such as soluble sugars and water-soluble polysaccharides, salt-soluble proteins and water-soluble pentosan, and insoluble polysaccharides such as insoluble pentosan are present.

In the present invention, the “aka-kasu” residue is a reddish brown mixture including water-insoluble fibers, such as hemicellulose and cellulose, proteins, sugars, and the like, which are composed of endosperm-derived minute pieces, and is recoverable, for example, by sieving (e.g., with a 150 to 300 mesh screen) a starch-containing emulsion (crude starch milk), which is produced by rinsing a kneaded product called “dough” or “batter” of wheat flour and water. The mass ratio between dietary fiber and protein in the “aka-kasu” residue can be, for example, 1.7 to 8.3:1.

The “aka-kasu” residue may be in a wet form or in a dry form. The “aka-kasu” residue in a wet form contains, for example, 85 to 90% by mass of water, 3.0 to 5.0% by mass of dietary fiber, and 0.6 to 1.8% by mass of protein.

In the present invention, the “shiro-kasu” residue is a white mixture including water-insoluble fibers, crude proteins, sugars, and the like, which are included in the endosperm, and is recoverable, for example, by centrifugal separation (e.g., at 1000 to 3000 G) of the starch milk that is obtained by removing the “aka-kasu” residue from the above-described crude starch milk. The mass ratio between dietary fiber and protein in the “shiro-kasu” residue can be, for example, 0.3 to 10.7:1.

The “shiro-kasu” residue may be in a wet form or in a dry form. The “shiro-kasu” residue in a wet form contains, for example, 85 to 90% by mass of water, 0.4 to 3.2% by mass of dietary fiber, and 0.3 to 1.5% by mass of protein.

The “aka-kasu” residue and the “shiro-kasu” residue are recoverable as by-products in the separation steps of the above-described process for producing wheat gluten and wheat starch.

The “aka-kasu” residue is recovered, for example, as a by-product of separation and recovery of wheat starch from washings liquid (crude starch milk) of dough or batter, and corresponds to, for example, a product obtained by dehydrating or drying a pentosan fraction, a light liquid phase liquid discharged from a three phase decanter, or a fraction including insoluble fibers obtained with a 150 to 300 mesh screen.

In addition, the “shiro-kasu” residue may be recovered as a by-product of separation and recovery of wheat starch or wheat gluten from washings (a starch-rich suspension (a starch phase or fraction, for example, A-starch-rich fraction including A-starch granules and/or B-starch-rich fraction including B-starch granules) and/or a gluten-rich suspension (protein-rich phase or gluten-rich fraction)), from which the above-described “aka-kasu” residue or the fraction including “aka-kasu” residue has been removed. The “shiro-kasu” residue corresponds, for example, to a product obtained by dehydrating or drying a residue (a soluble fraction including microfibers) obtained by recovering starch or gluten from the A-starch-rich fraction and/or B-starch-rich fraction, or the gluten-rich fraction, respectively.

The above-described separation and recovery may be performed by a method known in the art, more specifically, a separation method using a difference in specific gravity or a difference in particle diameter; examples of the method include centrifugal separation with a pore-free wall centrifugal separator, a nozzle centrifuge, a high-speed centrifugal sieve, or a hydro-cyclone, decantation with, for example, a three-phase decanter, and sieving with, for example, a vibrating sieve.

In addition, the mass ratio between dietary fiber and protein of wheat flour starch varies depending on the product grade even if it is made by a typical process for producing wheat protein and wheat flour starch; for example, wheat flour starch contains 0.9 to 1.4% by mass of dietary fiber and 0.6 to 0.9% by mass of protein, and the mass ratio is, for example, 1.0 to 2.3:1.

In the present invention, the “aka-kasu” residue having a mass ratio between dietary fiber and protein of, for example, 2.0 to 7.0:1, preferably 2.8 to 5.0:1, the “shiro-kasu” residue having a mass ratio between dietary fiber and protein of, for example, 0.5 to 5.0, preferably 1.3 to 2.1:1, and wheat flour starch having a mass ratio between dietary fiber and protein of, for example, 1.3 to 2.0:1, more preferably 1.5 to 1.6:1 may be used.

Therefore, in the present invention, the dietary fiber and the protein are preferably derived from a main product or a by-product of a process for producing wheat protein or wheat flour starch, and are preferably derived from the “aka-kasu” residue, the “shiro-kasu” residue, or the wheat flour starch.

Table 1 shows example chemical compositions of wheat flour starch A, wheat flour starch B, wheat flour starch C, and the “aka-kasu” residue, which were obtained through different purification processes (in different product grades). In Examples, the wheat flour starch A, the wheat flour starch B, and the “aka-kasu” residue are used for a working example while wheat flour starch C free from dietary fiber is used for a comparative example.

TABLE 1

| Component Contained | | Wheat Flour | | Wheat Flour | | Wheat Flour | | “aka-kasu” | |
|---|---|---|---|---|---|---|---|---|---|
| (Content: % by mass) | | Starch A | | Starch B | | Starch C | | residue | |
| Water | | 14.6 | | 11.8 | | 13.1 | | 87.9 | |
| Protein | | 0.9 | | 0.6 | | 0.2 | | 0.9 | |
| Lipid | | 1.1 | | 0.8 | | 0.5 | | 0.2 | |
| Total Ash | | 0.3 | | 0.3 | | 0.1 | | 0.1 | |
| Carbohydrate | Sugar | 83.1 | 81.7 | 86.5 | 85.6 | 86.1 | 86.1 | 10.9 | 6.6 |
| | Dietary Fiber | | 1.4 | | 0.9 | | 0.0 | | 4.3 |

### [Contents of Dietary Fiber and Protein]

In the present invention, a content of the dietary fiber in the meat-like protein composition is 0.2 to 3 parts by mass with respect to 100 parts by mass of gluten.

When the content of the dietary fiber is within the above range, a porous structure with a rugged surface and a fine network structure (fibrous material) will be formed, and thus the meat-like protein composition can be obtained, which has a meat-like fibrous texture and is capable of feeling a texture of natural meat when chewed.

The content of the dietary fiber is preferably 0.2 to 2.6 parts by mass, and more preferably 0.2 to 0.5 parts by mass in terms of texture, with respect to 100 parts by mass of gluten.

In the present invention, a content of the protein other than gluten in the meat-like protein composition is 0.08 to 0.7 parts by mass with respect to 100 parts by mass of gluten.

When the content of the protein is within the above range, a porous structure with a rugged surface and a fine network structure (fibrous material) will be formed, and the meat-like protein composition can be obtained, which has a meat-like fibrous texture and is capable of feeling a texture of natural meat when chewed.

The content of the protein is preferably 0.1 to 0.6 parts by mass, and more preferably 0.1 to 0.3 parts by mass in terms of texture, with respect to 100 parts by mass of gluten.

[Blending Ratio of Main Product or by-Product]

When using, as the dietary fiber and the protein, a wheat flour starch including dietary fibers and proteins, which is a main product obtained in a process for producing wheat protein or wheat flour starch, or an “aka-kasu” residue or an “shiro-kasu” residue, which is derived from a by-product in the production process, a blending ratio thereof may be appropriately determined depending on the contents of the dietary fiber and the protein included in the main product or the by-product.

When the blending ratio of the main product or the by-product is too small with respect to 100 parts by mass of gluten and therefore the amounts of the dietary fiber and the protein are too small with respect to 100 parts by mass of gluten, it will be difficult to form a porous structure with a rugged surface and a fine network structure (fibrous material), and the meat-like protein composition of the present invention may not be obtained. On the other hand, when the blending ratio of the main product or the by-product is too large with respect to 100 parts by mass of gluten, a flavor or a texture from the main product or the by-product may be imparted to the meat-like protein composition.

A preferred blending ratio of the main product or the by-product is, for example, from 15 to 90 parts by mass, more preferably from 15 to 60 parts by mass, with respect to 100 parts by mass of gluten.

As shown in Table 1, contents of dietary fiber and protein in the “aka-kasu” residue, the “shiro-kasu” residue, and the wheat flour starch are different, and thus preferable blending ratios thereof with respect to 100 parts by mass of gluten are also different.

When an “aka-kasu” residue having a water content of 85 to 90% by mass is used as the dietary fiber and the protein, a preferable blending ratio thereof is, for example, 15 to 70 parts by mass, and more preferably 20 to 60 parts by mass, with respect to 100 parts by mass of gluten.

When a “shiro-kasu” residue having a water content of 85 to 90% by mass is used, a preferable blending ratio thereof is, for example, 20 to 90 parts by mass, and more preferably 30 to 70 parts by mass, with respect to 100 parts by mass of gluten.

When a wheat flour starch having a water content of 10 to 20% by mass is used, a preferable blending ratio thereof is, for example, 15 to 35 parts by mass, and more preferably 18 to 30 parts by mass, with respect to 100 parts by mass of gluten.

The “aka-kasu” residue and “shiro-kasu” residue are preferably dried and powdered from the viewpoint of improving workability and drying efficiency in a mixing step and a drying step in the production of the meat-like protein composition.

In addition, since the “aka-kasu” residue includes a larger amount of dietary fiber than the “shiro-kasu” residue and wheat flour starch, a smaller amount of “aka-kasu” residue to be added can produce an excellent effect of the meat-like protein composition of the present invention, and also allow efficient use of resources that have been discarded; the “aka-kasu” residue is thus particularly preferable as an additive component.

### [Other Protein]

The meat-like protein composition of the present invention may include another protein(s) as long as it does (they do) not impair functional properties such as texture and flavor of meat-like food, which are the effects of the present invention.

Examples of the other protein include plant proteins such as proteins derived from grain seeds such as rice and barley, and proteins extracted and processed therefrom, for example, rice glutelin, barley prolamin, soy globulin, soy albumin, peanut albumin and the like, as well as heat-, acid-, alkaline-, or enzyme-treated proteins thereof, and mixtures thereof.

In addition, animal proteins may also be used, and examples thereof include egg white, gelatin, whey protein, casein, as well as plasma-processed products thereof, and extracted products thereof.

The blending ratio of the other protein may be appropriately determined according to their protein type and is about 3 to 30 parts by mass with respect to 100 parts by mass of gluten.

On the other hand, the meat-like protein composition of the present invention is preferably free from lipoxygenase.

### [Other Raw Material]

The meat-like protein composition of the present invention may include another raw material(s) depending on the purpose of use, as long as it does (they do) not impair functional properties such as texture and flavor of meat-like food, which are the effects of the present invention.

Examples of the other raw material include various seasonings and oils and fats, and various food additives for enhancing texture such as hardness and elasticity. Examples thereof include various salts such as common salt, calcium lactate, calcined calcium, and tripolyphosphates, enzymes such as transglutaminase, thickening polysaccharides, starches, and spices.

The blending ratio of the other raw material may be appropriately determined according to the type of the raw material and is about 0.3 to 20 parts by mass with respect to 100 parts by mass of gluten.

### [Structure and Water Absorption Capacity of Meat-Like Protein Composition]

The meat-like protein composition of the present invention has a water absorption capacity of 300 to 400% of the dry mass.

The water absorption capacity represents a degree to which the meat-like protein composition can absorb and retain water with respect to the dry mass, and a specific measurement method thereof will be described in Examples.

In addition, the meat-like protein composition of the present invention preferably has a porous structure with a rugged surface, and further preferably includes a fibrous matter in the structure.

The water absorption capacity serves as an indicator of how porous and rugged the structure of the meat-like protein composition is and how much fibrous matters are included in the structure.

When the water absorption capacity of a meat-like protein composition is less than 300% by mass, the meat-like protein composition may not or may partially have a porous structure with fibrous matters, which is peculiar to the present invention, making it difficult to obtain the effect of the present invention. On the other hand, when the water absorption capacity of a meat-like protein composition exceeds 400% by mass, dehydration efficiency of the meat-like protein composition may decrease and drying may take a long time.

A preferred water absorption capacity is 300 to 340% by mass.

### [Method for Producing Meat-Like Protein Composition]

A method for producing a meat-like protein composition of the present invention is characterized by including a step of mixing a gluten with 0.2 to 3 parts by mass of a dietary fiber derived from wheat grain and 0.08 to 0.7 parts by mass of a protein derived from wheat grain other than the gluten, with respect to 100 parts by mass of the gluten.

Note that details of components and mass ratios are as in the “Meat-like Protein Composition”.

The meat-like protein composition of the present invention can be obtained by mixing a gluten with a specific amount of a dietary fiber derived from wheat grain and a protein derived from wheat grain other than the gluten, that is, a simpler production method than those for a conventional meat-like protein composition, which require heating, pressurization, microwave irradiation, and/or addition of acidic sodium sulfite for structure modification.

When an “aka-kasu” residue, a “shiro-kasu” residue or a wheat flour starch is used as a dietary fiber derived from wheat grain and a protein derived from wheat grain other than the gluten, the gluten is preferably mixed with 2 to 30 parts by mass of the “aka-kasu” residue, the “shiro-kasu” residue or the wheat flour starch with respect to 100 parts by mass of the gluten.

Hereinafter, an example of the method for producing the meat-like protein composition of the present invention will be described; however, the present invention is not limited thereto.

### (Mixing)

A gluten is mixed with specific amounts of a dietary fiber derived from wheat grain and a protein derived from wheat grain other than the gluten.

For the mixing, a known mixing apparatus used for food processing, in particular, a mixing apparatus capable of mixing high viscosity materials, such as a food cutter, a Stephan cutter, or a twin-screw kneading extruder, may be used.

Mixing conditions may be set appropriately according to the mixing apparatus used, kinds of raw materials, processing volume, and the like. For example, processing time is typically 90 seconds or less when the mixing apparatus is a high-speed rotating food cutter and is typically about 10 to 60 minutes when the mixing apparatus is a low-speed kneader.

Prolonged and excessive mixing can develop the viscoelasticity peculiar to gluten, which may make the meat-like protein composition difficult to be dried and/or reconstituted. On the other hand, when the mixing is too short, the dough may not bind well, which may make it difficult to obtain the meat-like protein composition having a desired size.

A mixing temperature is not higher than the denaturation temperature of the gluten, typically not higher than 60° C., preferably not higher than 50° C., and a lower limit thereof is about 10° C.

When a wheat flour starch is used as the dietary fiber derived from wheat grain and the protein derived from wheat grain other than gluten, it is preferred to blend an amylolytic enzyme such as amylase.

A blending amount of amylolytic enzyme should be sufficient to break down the starch in the wheat flour starch; for example, in the case of amylase having an enzyme activity of 30,000 units/g, the blending amount is about 0.06 to 6 parts by mass, preferably about 0.2 to 2 parts by mass, with respect to 100 parts by mass of the gluten.

By blending an amylolytic enzyme to hydrolyze and remove the starch, it is possible to avoid an adverse effect on texture due to gelatinized starch paste and a decrease in drying efficiency during production.

### (Shaping)

The raw material mixture obtained by the mixing is shaped into a desired shape such as a granular shape, a sheet shape, a block meat shape, or a diced shape. For the shaping, a known shaping apparatus, such as a meat chopper used for food processing, or a known mold can be used, and conditions therefor may be appropriately set depending on the shaping apparatus or the mold to be used, kinds of raw materials, processing volume, or the like.

### (Heat Coagulation)

The shaped mixture is then heated and coagulated. For the heat coagulation, a known apparatus used for food processing can be used. Examples of the method include a method of soaking the raw material mixture in hot water, steam heating, microwave heating, and twin-screw extruder cooking.

A temperature condition is preferably 50 to 120° C., and particularly preferably 80 to 95° C. in order to avoid progress of oxidation of lipid included in the wheat protein as much as possible.

### (Drying)

By incorporating a drying step to utilize the protein denaturation action during drying, a texture more similar to that of farm animal flesh can be obtained.

For the drying, a known drying apparatus used for food processing may be used.

A drying temperature is preferably 50 to 120° C., and particularly preferably 80 to 95° C. in order to avoid progress of oxidation of lipid included in the wheat protein as much as possible.

The meat-like protein composition of the present invention may be either in a dry form or a wet form. In the case of a dry form, a water content thereof is about 0 to 10% by mass, and in the case of a wet form, a water content is about 30 to 80% by mass.

### [Meat-Like Food Product]

The meat-like food product of the present invention includes the meat-like protein composition of the present invention.

A shape of the meat-like food product is not particularly limited, and the meat-like food may be processed into a desired shape according to the application (how it is cooked). For example, it can be processed into a shape of steak meat or cutlet meat having a thickness of about 15 mm or more, a shape of meat for stewed dishes such as curry or stew having a length of about 15 mm or more per side, a shape of meat for fried chicken, chicken nuggets, or grilled chicken, or a shape of minced meat.

Known apparatuses and methods may be used for such processing.

The meat-like food product of the present invention includes a food processed from the meat-like protein composition of the present invention.

The processed food may be obtained, for example, by processing the meat-like protein composition of the present invention in a minced state and then into a desired shape, and cooking it together with other food materials.

Specific examples thereof include meatballs, hamburger patties, Chinese buns, dumplings, and shao-mai.

The meat-like protein composition of the invention is a substitute for real meat; the substitution may be complete or partial. That is, the processed food may include both the real meat and the meat-like protein composition of the present invention.

When a dry form of the meat-like protein composition of the present invention is rehydrated to be used for a meat-like food product, a water content after the rehydration is about 50 to 80% by mass.

### [Additive Composition and Use of Composition]

An additive composition of the present invention includes a dietary fiber derived from wheat grain and a protein derived from wheat grain other than a gluten at a mass ratio of 0.2 to 3:0.08 to 0.7, for production of a meat-like protein composition including the gluten.

In addition, use of the composition of the present invention is use of a composition including a dietary fiber derived from wheat grain and a protein derived from wheat grain other than a gluten at a mass ratio of 0.2 to 3:0.08 to 0.7, for production of a meat-like protein composition including the gluten.

In the “additive composition” and the “use of composition”, the “dietary fiber derived from wheat grain” and the “protein derived from wheat grain other than gluten” are as described above under “Meat-like Protein Composition.”

A mass ratio between the dietary fiber between the protein in the additive composition of the present invention is preferably 0.2 to 2.6:0.1 to 0.6, and more preferably 0.2 to 0.5:0.1 to 0.3 in terms of texture.

In the present invention, a wheat flour starch, which is a main product of the production process of wheat protein or wheat flour starch, as well as an “aka-kasu” residue and a “shiro-kasu” residue, which are from by-products of the production process can be used as the additive composition.

### EXAMPLES

The present invention will be described in more detail with reference to Experiments including Examples and Comparative Examples, but the present invention is not limited thereto.

### [Experimental 1: Preparation and Evaluation of Meat-Like Protein Composition]

Meat-like protein compositions including a gluten, s dietary fiber derived from wheat grain and a protein derived from wheat grain other than the gluten were prepared, and for comparison, a meat-like protein composition not including a dietary fiber or a protein and meat-like protein compositions using conventional additives in place of dietary fiber and protein were prepared and they were evaluated.

### Example 1

Two hundreds parts by mass of water (tap water) was added to 100 parts by mass of wheat protein (manufactured by Nagata Sangyo Co., Ltd., product name: Powdered Wheat Protein Fumelit A2) as a gluten raw material, and the mixture was mixed for 120 seconds at a speed of 1500 rpm using a food processor (manufactured by Robot-Coupe, model: ROBOT COUPE S type R-100) to obtain a paste mixture (“raw gluten”, hereinafter also referred to as “paste”).

Then, to 100 parts by mass of the obtained paste (containing 33% by mass of gluten) were added 6 parts by mass (with respect to 100 parts by mass of gluten, 18 parts by mass) of wheat flour starch A as a dietary fiber and a protein (water content: 14.6% by mass, dietary fiber content: 1.4% by mass, protein content: 0.9% by mass, Table 1) and 0.1 parts by mass (with respect to 100 parts by mass of gluten, 0.3 parts by mass) of α-amylase (from Bacillus Subtilis, enzyme activity: 30000 units/g, manufactured by Nagase & CO., LTD, product name: Spitase CP-3), and the mixture was mixed at a speed of 1500 rpm for 50 seconds.

The obtained mixture was processed with a meat chopper (manufactured by KITAZAWA SANGYO CO., LTD., model: C-12A, outlet φ3 mm), subsequently fed into a boiling tank, and boiled at a temperature of 98° C. for 30 minutes.

The obtained boiled product was cooled under running water and dehydrated so as to have a water content of about 60% by mass, and then dried at a temperature of 95° C. for 60 minutes using a constant-temperature and drying oven (manufactured by MASUDA

CORPORATION, model: DRYING OVEN SA-46) to obtain about 93 g of a meat-like protein composition.

### Example 2

About 95 g of a meat-like protein composition was obtained in the same manner as in Example 1, except that 24 parts by mass of the wheat flour starch A was used with respect to 100 parts by mass of gluten.

### Example 3

About 97 g of a meat-like protein composition was obtained in the same manner as in Example 1, except that 30 parts by mass of the wheat flour starch A was used with respect to 100 parts by mass of gluten.

### Example 4

About 96 g of a meat-like protein composition was obtained in the same manner as in Example 1, except that 30 parts by mass of wheat flour starch B (water content: 11.8% by mass, dietary fiber content: 0.9% by mass, protein content: 0.6% by mass, Table 1) instead of the wheat flour starch A was used with respect to 100 parts by mass of gluten.

### Comparative Example 1

About 92 g of a meat-like protein composition was obtained in the same manner as in Example 1, except that neither the wheat flour starch A nor α-amylase was used.

### Comparative Example 2

About 95 g of a meat-like protein composition was obtained in the same manner as in Example 1, except that 12 parts by mass of the wheat flour starch A was used with respect to 100 parts by mass of gluten.

### Comparative Example 3

About 95 g of a meat-like protein composition was obtained in the same manner as in Example 1, except that 30 parts by mass of wheat flour starch C (water content: 13.1% by mass, dietary fiber content: 0.0% by mass, protein content: 0.2% by mass, Table 1) instead of the wheat flour starch A was used with respect to 100 parts by mass of gluten.

### Comparative Example 4

About 95 g of a meat-like protein composition was obtained in the same manner as in Example 1, except that 0.9 parts by mass of xanthan gum (manufactured by DSP Gokyo Food & Chemical Co., Ltd., product name: ECHO GUM) as polysaccharide, instead of the wheat flour starch A, was used with respect to 100 parts by mass of gluten, and no α-amylase was used.

### Comparative Example 5

About 94 g of a meat-like protein composition was obtained in the same manner as in Example 1, except that 0.9 parts by mass of water-soluble soy polysaccharide (average molecular weight: 550000, galacturonic acid content: 18.3% by mass, manufactured by FUJI OIL CO., LTD., product name: SOYAFIBE-S) instead of the wheat flour starch A was used with respect to 100 parts by mass of gluten, and no α-amylase was used.

### Comparative Example 6

About 94 g of a meat-like protein composition was obtained in the same manner as in Example 1, except that 0.9 parts by mass of wheat fiber (manufactured by Rettenmaier Japan Co., Ltd., product name: Vitacel WF200) instead of the wheat flour starch A was used with respect to 100 parts by mass of gluten, and no α-amylase was used.

### Comparative Example 7

About 95 g of a meat-like protein composition was obtained in the same manner as in Example 1, except that 1.5 parts by mass of soy protein (manufactured by The Nisshin OilliO Group, Ltd., product name: Sorpy 4000H) instead of the wheat flour starch A was used with respect to 100 parts by mass of gluten, and no α-amylase was used.

### Comparative Example 8

About 94 g of a meat-like protein composition was obtained in the same manner as in Example 1, except that 0.9 parts by mass of water-soluble soy polysaccharide (average molecular weight: 550000, galacturonic acid content: 18.3% by mass, manufactured by FUJI OIL CO., LTD., product name: SOYAFIBE-S) and 1.5 parts by mass of soy protein (manufactured by The Nisshin OilliO Group, Ltd., product name: Sorpy 4000H), with respect to 100 parts by mass of gluten, were used instead of the wheat flour starch A, and no α-amylase was used.

The obtained meat-like protein compositions of Examples 1 to 4 and Comparative Examples 1 to 8 were evaluated for water absorption capacity, texture, and appearance (tissue structure), and the results obtained were comprehensively evaluated.

### [Evaluation 1: Water Absorption Capacity]

About 30 g (mass before water absorption (dry mass): Wb) of each of the obtained meat-like protein compositions was weighed, and fed into a vessel containing water in an amount of 5 times the mass of the meat-like protein composition and allowed to stand for 60 minutes. Thereafter, the hydrous meat-like protein compositions were drained in a colander, and weighed (mass after water absorption: Wa). Water absorption capacity (% by mass) was calculated from the obtained results and scored according to the following scoring criteria.

$$Water absorption capacity ( \% by mass ) = ( Wa / Wb ) \times 100$$

### (Scoring Criteria)

| Score | Water absorption capacity |
|---|---|
| 4 | 300% by mass or more and 400% by mass or less |
| 3 | 250% by mass or more and less than 300% by mass |
| 2 | 200% by mass or more and less than 250% by mass |
| 1 | 100% by mass or more and less than 200% by mass |

### [Evaluation 2: Texture]

Sensory evaluation (scoring) of hardness, elasticity and juiciness was performed on the water-absorbed meat-like protein compositions (test products) by five trained panelists according to the following four-level scoring criteria. The average of these scores (rounded down to the first decimal place) was used as an evaluation score for texture.

### (Scoring Criteria)

| Score | |
|---|---|
| 4 | A juicy texture similar to natural meat, with a good balance |
| | between hardness and elasticity. |
| 3 | A juicy texture similar to natural meat, but with elasticity |
| | slightly greater than hardness. |
| 2 | A juicy texture close to natural meat, but slightly unnatural |
| | due to the elasticity being greater than the hardness. |
| 1 | A consistent, artificial texture with a rubbery, unnatural |
| | elasticity that makes it too hard to bite off, or a rough and |
| | unnatural texture with a strange taste and odor. |

### [Evaluation 3: Tissue Structure]

Each of the obtained meat-like protein compositions (in a dry form) was observed using an optical microscope (manufactured by KEYENCE CORPORATION, model: Digital Microscope VHX5000) at a magnification of 20 times, and the tissue structure thereof was scored according to the following scoring criteria.

### (Scoring Criteria)

| Score | |
|---|---|
| 4 | The appearance has a rugged shape and a porous structure, and |
| | fibrous matters are observed in the tissue structure. |
| 3 | The appearance has a slightly less rugged shape and a porous |
| | structure, and fibrous matters were observed in the tissue structure. |
| 2 | The appearance has a less rugged shape and a less porous structure, |
| | and almost no fibrous matters were observed in the tissue structure. |
| 1 | The appearance has a dense and smooth structure, and no fibrous |
| | matters were observed in the tissue structure. |

### [Comprehensive Evaluation]

The results of water absorption capacity, texture, and appearance (tissue structure) were comprehensively evaluated according to the following criteria.
∘ (Good): Water absorption capacity, texture, and appearance scores are all 3.0 or higher.
× (No good): At least one of the water absorption capacity, texture, and appearance scores is less than 3.0.

The obtained results are shown in Table 2 together with the ingredients of the meat-like protein compositions.

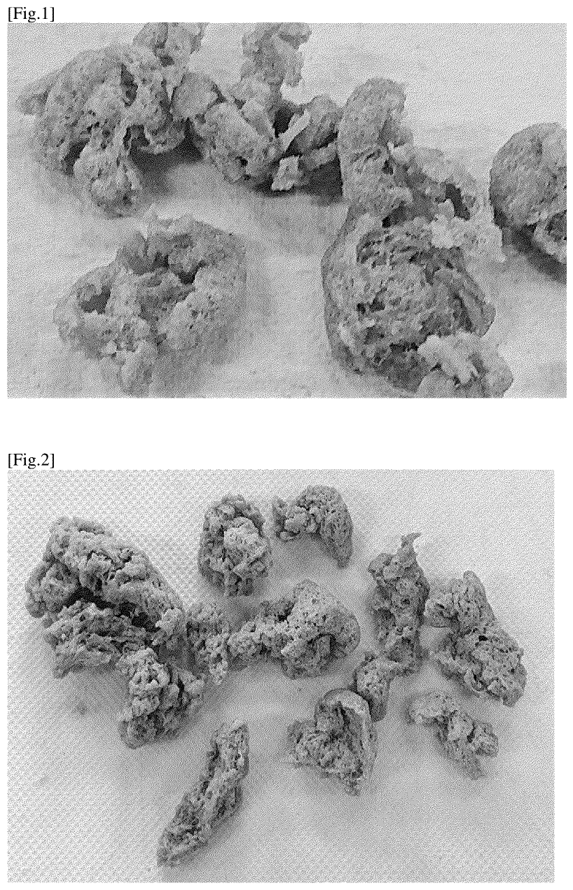

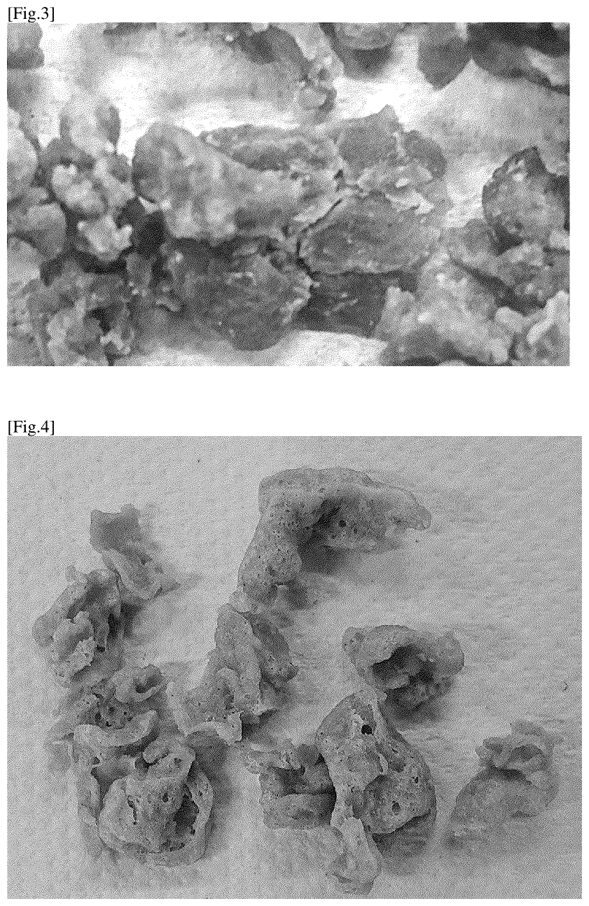

In addition, FIGS. 1 to 4 are optical photomicrographs (20×) showing the appearances of the meat-like protein compositions obtained in Example 1, Example 2, Comparative Example 1, and Comparative Example 3.

TABLE 2

| | Meat-like Protein Composition (Blended Amount: with respect to 100 parts by mass of gluten) | | | | | | |
|---|---|---|---|---|---|---|---|
| | Blended Material and Blended Amount | | | | | Substitute for | |
| | | Dietary | | | α-Amylase | Blended Material | |
| | | Fiber | Protein | Blended | Blended | | Blended |
| | | Content | Content | Amount | Amount | | Amount |
| | | (parts | (parts | (parts | (parts | | (parts |
| | Material | by mass) | by mass) | by mass) | by mass) | Material | by mass) |
| Example 1 | Wheat Flour | 0.25 | 0.16 | 18 | 0.3 | — | — |
| | Starch A | | | | | | |
| Example 2 | Wheat Flour | 0.34 | 0.22 | 24 | 0.3 | — | — |
| | Starch A | | | | | | |
| Example 3 | Wheat Flour | 0.42 | 0.27 | 30 | 0.3 | — | — |
| | Starch A | | | | | | |
| Example 4 | Wheat Flour | 0.27 | 0.18 | 30 | 0.3 | — | — |
| | Starch B | | | | | | |
| Comparative | — | 0 | 0 | 0 | — | — | — |
| Example 1 | | | | | | | |
| Comparative | Wheat Flour | 0.16 | 0.11 | 12 | 0.3 | — | — |
| Example 2 | Starch A | | | | | | |
| Comparative | Wheat Flour | 0 | 0.06 | 30 | 0.3 | — | — |
| Example 3 | Starch C | | | | | | |
| Comparative | — | — | — | — | — | Polysaccharide | 0.9 |
| Example 4 | | | | | | | |
| Comparative | — | — | — | — | — | Water-soluble | 0.9 |
| Example 5 | | | | | | Soy | |
| | | | | | | Polysaccharide | |
| Comparative | — | — | — | — | — | Wheat Fiber | 0.9 |
| Example 6 | | | | | | | |
| Comparative | — | — | — | — | — | Soy Protein | 1.5 |
| Example 7 | | | | | | | |
| Comparative | — | — | — | — | — | Water-soluble | 0.9 |
| Example 8 | | | | | | Soy | |
| | | | | | | Polysaccharide | |
| | | | | | | Soy Protein | 1.5 |

| | Evaluation | | | | |
|---|---|---|---|---|---|
| | Water Absorbability | | | | |
| | Water | | | | |
| | Absorption | | | | |
| | Capacity | | Texture | Appearance | Comprehensive |
| | (% by mass) | Score | Score | Score | Evaluation |
| Example 1 | 300 | 4 | 3.5 | 3 | ∘ |
| Example 2 | 330 | 4 | 3.7 | 4 | ∘ |
| Example 3 | 340 | 4 | 3.8 | 4 | ∘ |
| Example 4 | 300 | 4 | 3.7 | 4 | ∘ |
| Comparative | 150 | 1 | 1.2 | 1 | x |
| Example 1 | | | | | |
| Comparative | 250 | 3 | 2.3 | 3 | x |
| Example 2 | | | | | |
| Comparative | 180 | 1 | 2.2 | 2 | x |
| Example 3 | | | | | |
| Comparative | 220 | 2 | 2.2 | 2 | x |
| Example 4 | | | | | |
| Comparative | 235 | 2 | 2.5 | 2 | x |
| Example 5 | | | | | |
| Comparative | 230 | 2 | 2.0 | 2 | x |
| Example 6 | | | | | |
| Comparative | 165 | 1 | 1.6 | 2 | x |
| Example 7 | | | | | |
| Comparative | 155 | 1 | 2.4 | 2 | x |
| Example 8 | | | | | |

The results in Table 2 show the following:
(1) The meat-like protein compositions, having a dietary fiber and a protein added, according to the present invention had the appearance with a rugged shape and a porous structure, were found to contain fibrous matters in the tissue structure, and had excellent water absorption capacity. They had a juicy texture similar to natural meat, with a good balance between hardness and elasticity (Examples 1 to 4).
(2) The meat-like protein compositions having no dietary fiber or protein added, and the meat-like protein compositions having a dietary fiber and a protein added but not as defined in the present invention, had the appearance with a less rugged shape and a less porous structure, and were found to contain almost no fibrous matters in the tissue structure. Therefore, they had a lower water absorption capacity, and an unusual texture quite different from meat due to the elasticity being greater than the hardness (Comparative Examples 1 to 3).
(3) The meat-like protein compositions having added polysaccharides, or dietary fiber and/or protein, other than those defined in the present invention, had the appearance with a less rugged shape and a less porous structure, and were found to contain almost no fibrous matters in the tissue structure. Therefore, they had a lower water absorption capacity, and an usual texture different from meat due to the elasticity being greater than the hardness (Comparative Examples 4 to 8).

### [Experiment 2: Preparation and Evaluation of Meat-Like Food]

The meat-like protein compositions obtained in Example 3 and Comparative Example 1 of Experiment 1 and a conventional meat-like protein composition as a control were used to prepare ground-meat-like food products, which were then evaluated.

### Example 5

One hundred parts by mass of the meat-like protein composition obtained in Example 3 of Experiment 1 were rehydrated and reconstituted (water content: about 69% by mass).

A seasoning liquid was prepared according to the following formula.

| | | |
|---|---|---|
| Common salt (manufactured by The Salt | 6 | parts by mass |
| Industry Center of Japan, product name: | | |
| Namishio) | | |
| Sugar (manufactured by Mitsui Sugar | 12 | parts by mass |
| Co., Ltd., product name: caster sugar) | | |
| Chicken extract (manufactured by Nikken | 25 | parts by mass |
| Foods Co., Ltd., product name: chicken | | |
| extract A-5410) | | |
| Chicken paste (manufactured by Fuji | 10 | parts by mass |
| Foods Corporation, product name: | | |
| chicken extract C-500(S)) | | |
| Yeast extract (manufactured by Koyo | 5 | parts by mass |
| Mercantile Co., Ltd., product name: | | |
| Springer 4101/0-PW-L) | | |
| Monosodium glutamate (manufactured | 1.0 | part by mass |
| by DSP Gokyo Food & Chemical Co., | | |
| Ltd., product name: sodium glutamate RC) | | |
| Water (tap water) | 200 | parts by mass |

The above raw materials for a seasoning liquid were added to water and stirred for 5 minutes at a speed of 6000 rpm using a homogenizer (manufactured by PRIMIX Corporation, model: TK Homomixer MARK II) to obtain the seasoning liquid.

In 259 parts by mass of the obtained seasoning liquid, 100 parts by mass of the rehydrated meat-like protein composition was immersed and allowed to stand at room temperature (25° C.) for 1 hour to soak up the seasoning liquid. After standing, the meat-like protein composition was separated from the excess seasoning liquid (immersion liquid) using a 1 mm-mesh wire screen

Next, 20 g of a commercially available salad oil was heated in a frying pan (outer diameter 280 mm) on an IH cooker to a temperature of 100° C., and then the meat-like protein composition was thoroughly fried in the oil for 3 minutes, and subsequently allowed to cool at room temperature (25° C.) which is the product temperature after cooling, for 1 hour to obtain about 120 g of a fried ground-meat-like food product (Sample 1).

### Comparative Example 9

About 110 g of a fried ground-meat-like food product (Sample 2) was obtained in the same manner as in Example 5, except that the meat-like protein composition obtained in Comparative Example 1 of Experiment 1 was used instead of the meat-like protein composition obtained in Example 3 of Experiment 1.

### Comparative Example 10

About 107 g of a fried ground-meat-like food product (Sample 3) was obtained in the same manner as in Example 5, except that granular soy protein (manufactured by FUJI OIL CO., LTD., product name: New Fujinic 52S) was used instead of the meat-like protein composition obtained in Example 3 of Experiment 1.

The texture and flavor of the ground-meat-like food products (Samples 1 to 3) obtained in Example 5 and Comparative Examples 9 and 10 were evaluated, and the results thus obtained were comprehensively evaluated.

Sensory evaluation (scoring) of texture and flavor was performed on the ground-meat-like food products by five trained panelists according to the following four scoring criteria. The average of these scores (rounded down to the first decimal place) was used as an evaluation score for texture and flavor.

### [Evaluation 4: Texture]

### (Scoring Criteria)

| Score | |
|---|---|
| 4 | Juicy with a very strong feeling of granular meat. |
| 3 | Slightly juicy with a strong feeling of granular meat. |
| 2 | A little juicy with a slightly strong feeling of granular meat. |
| 1 | Not juicy with a weak feeling of granular meat. |

### [Evaluation 4: Flavor]

### (Scoring Criteria)

| Score | |
|---|---|
| 4 | Almost no odor of plant protein. |
| 3 | Slight odor of plant protein |
| 2 | Slightly strong odor of plant protein |
| 1 | Very strong odor of plant protein |

### [Comprehensive Evaluation]

The results of texture and flavor were comprehensively evaluated according to the following criteria.
∘ (Good): Texture and flavor scores are both 3.0 or higher.
× (No good): At least one of the texture and flavor score is less than 3.0.

The obtained results are shown in Table 3 together with the ingredients of the fried ground-meat-like food product.

TABLE 3

| | | Ground-meat-like Food Product | | | | | |
|---|---|---|---|---|---|---|---|
| | | Meat-like Protein Composition | | Seasoning Liquid | Score/Evaluation | | |
| | | | Blended Amount | Blended Amount | | | Comprehensive |
| | | Material | (parts by mass) | (parts by mass) | Texture | Flavor | Evaluation |
| Example 5 | Sample 1 | Composition of Example 3 | 100 | 100 | 3.6 | 3.5 | ∘ |
| Comparative | Sample 2 | Composition of | | | 2.3 | 3.1 | x |
| Example 9 | | Comparative Example 1 | | | | | |
| Comparative | Sample 3 | Granular Soy Protein | | | 1.3 | 2.4 | x |
| Example 10 | | | | | | | |

From the results shown in Table 3, it can be seen that the ground-meat-like food product (Sample 1) prepared using the meat-like protein composition obtained in Example 3 of Experiment 1 had a very strong granular feeling, was juicy, had good chewiness, and had little plant protein odor, as compared with the ground-meat-like food product (Sample 2) prepared using the meat-like protein composition obtained in Comparative Example 1 of Experiment 1 and the ground-meat-like food product (Sample 3) prepared using the granular soy protein.

### [Experiment 3: Preparation and Evaluation of Meat-Like Protein Composition]

Using raw gluten and an “aka-kasu” residue as dietary fiber and protein in varying amounts, meat-like protein compositions were prepared and evaluated.

### Example 6

Five parts by mass (15 parts by mass with respect to 100 parts by mass of gluten) of an “aka-kasu” residue (water content: 87.9% by mass, dietary fiber content: 4.3% by mass, protein content: 0.9% by mass; Table 1) were added to 100 parts by mass of raw gluten (gluten: 33% by mass, water content: 67% by mass), which had been separated from wheat flour by the Martin process, and the mixture was mixed for 120 seconds at a speed of 1500 rpm using a food processor (manufactured by Robocope, model: ROBOT COUPE S type R-100).

The obtained mixture was processed with a meat chopper (manufactured by KITAZAWA SANGYO CO., LTD., model: C-12A, outlet 3 mm), subsequently fed into a boiling tank, and boiled at a temperature of 98° C. for 30 minutes.

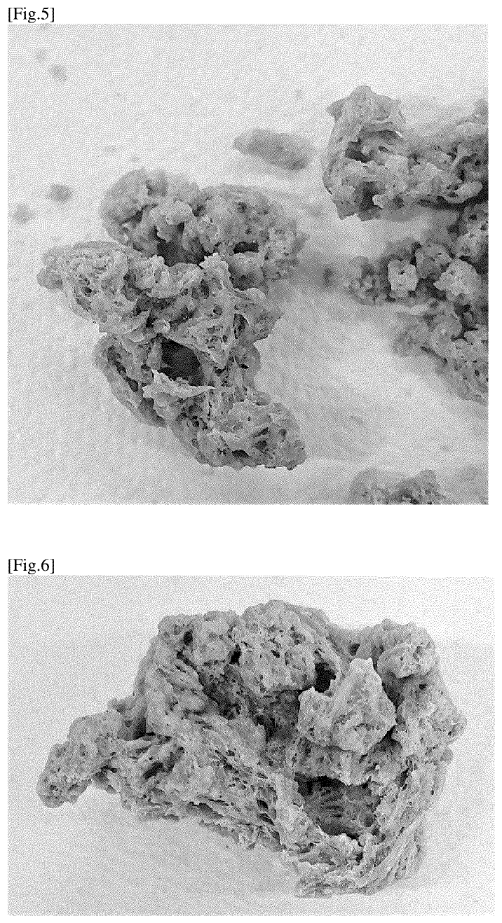

The obtained boiled product was cooled under running water and dehydrated so as to have a water content of about 60% by mass, and then dried at a temperature of 95° C. for 60 minutes using a constant-temperature and drying oven (manufactured by MASUDA CORPORATION, model: DRYING OVEN SA-46) to obtain about 36 g of a meat-like protein composition. It was confirmed optical microscopically that the obtained composition had a fine network structure (FIG. 5).

### Example 7

About 36 g of a meat-like protein composition was obtained in the same manner as in Example 6, except that 30 parts by mass of the “aka-kasu” residue was used with respect to 100 parts by mass of gluten. It was confirmed optical microscopically that the obtained composition had a fine network structure (FIG. 6).

### Example 8

About 35 g of a meat-like protein composition was obtained in the same manner as in Example 6, except that 60 parts by mass of the “aka-kasu” residue was used with respect to 100 parts by mass of gluten.

### Comparative Example 11

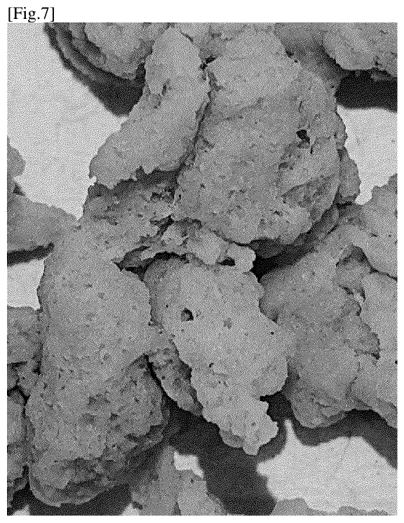

About 35 g of a meat-like protein composition was obtained in the same manner as in Example 6, except that 1.5 parts by mass of the “aka-kasu” residue was used with respect to 100 parts by mass of gluten. It was confirmed optical microscopically that the obtained mixture had no fine network structure (FIG. 7).

### Comparative Example 12

About 35 g of a meat-like protein composition was obtained in the same manner as in Example 6, except that 4.5 parts by mass of the “aka-kasu” residue was used with respect to 100 parts by mass of gluten.

### Comparative Example 13

About 35 g of a meat-like protein composition was obtained in the same manner as in Example 6, except that 7.5 parts by mass of the “aka-kasu” residue was used with respect to 100 parts by mass of gluten.

### Comparative Example 14

About 38 g of a meat-like protein composition was obtained in the same manner as in Example 6, except that 75 parts by mass of the “aka-kasu” residue was used with respect to 100 parts by mass of gluten.

In the same manner as in Experiment 1, the obtained meat-like protein compositions of Examples 6 to 8 and Comparative Examples 11 to 14 were evaluated for water absorption capacity, texture, and appearance (tissue structure), and the results obtained were comprehensively evaluated.

The obtained results are shown in Table 4 together with the ingredients of the meat-like protein compositions as well as the result of Comparative Example 1 of Experiment 1 as a control.

TABLE 4

| | Additive Material and Added Amount | | | Score/Evaluation | | | | |
|---|---|---|---|---|---|---|---|---|
| | “aka-kasu” residue | | | | | | | |
| | Blending Amount | | | Water Absorbability | | | | |
| | With Respect to | | Protein | Water | | | | |
| | 100 Parts by Mass | Dietary Fiber | Content | Absorption | | | | |
| | of Gluten | Content | (parts by | Capacity | | Texture | Appearance | Comprehensive |
| | (parts by mass) | (parts by mass) | mass) | (% by mass) | score | score | score | Evaluation |
| Example 6 | 15 | 0.65 | 0.14 | 300 | 4 | 3.2 | 3 | ∘ |
| Example 7 | 30 | 1.29 | 0.27 | 320 | 4 | 3.1 | 4 | ∘ |
| Example 8 | 60 | 2.58 | 0.54 | 340 | 4 | 3.0 | 4 | ∘ |
| Comparative Example 1* | 0 | 0 | 0 | 150 | 1 | 1.2 | 1 | x |
| Comparative Example 11 | 1.5 | 0.06 | 0.01 | 200 | 2 | 2.3 | 2 | x |
| Comparative Example 12 | 4.5 | 0.19 | 0.04 | 230 | 2 | 2.8 | 2 | x |
| Comparative Example 13 | 7.5 | 0.32 | 0.07 | 250 | 3 | 2.8 | 3 | x |
| Comparative Example 14 | 75 | 3.23 | 0.68 | 340 | 4 | 1.6 | 4 | x |

The results in Table 4 show the following:
(1) The meat-like protein compositions, having an “aka-kasu” residue added as dietary fiber and the protein, according to the present invention had the appearance with a rugged shape and a porous structure, were found to contain fibrous matters in the tissue structure, and had excellent water absorption capacity. They had a juicy texture similar to natural meat, with a good balance between hardness and elasticity (Examples 6 to 8).
(2) The meat-like protein compositions, having a dietary fiber and a protein but not as defined in the present invention, had the appearance with a less rugged shape and a less porous structure, and were found to contain almost no fibrous matters in the tissue structure. Therefore, they had a lower water absorption capacity, and an unusual texture quite different from meat due to the elasticity being greater than the hardness (Comparative Examples 11 to 13).
(3) The meat-like protein composition, in which a dietary fiber and a protein as defined in the present invention had been excessively added, had the appearance with a rugged shape and a porous structure, was found to contain fibrous matters in the tissue structure, and had excellent water absorption capacity structure. However, it had a rough and unnatural texture and a strange taste and odor due to the additives (Comparative Example 14).

### [Experiment 4: Preparation and Evaluation of Meat-Like Processed Food]

Using the meat-like protein compositions obtained in Example 6 of Experiment 3 and Comparative Example 1 of Experiment 1 and a conventional meat-like protein composition as a control, meatless hamburger patties were prepared and evaluated.

### Example 9

The meat-like protein composition obtained in Example 6 of Experiment 3 was rehydrated and reconstituted (water content: about 68% by mass).

To 20 parts by mass of the rehydrated meat-like protein composition, the following other raw materials were added, and the mixture was mixed for 20 seconds at a speed of 1500 rpm using a food processor (manufactured by Robot-Coupe, model: ROBOT COUPE S type R-100) to obtain about 80 g of the blend.

### (Other Raw Materials)

Powdered Soy protein (manufactured by The Nisshin OilliO Group, Ltd., product name: Sorpy 4000H) 9 parts by mass
Stir-fried onion 7 parts by mass
Sugar (manufactured by Mitsui Sugar Co., Ltd., product name: caster sugar) 1 part by mass
Monosodium glutamate (manufactured by DSP Gokyo Food & Chemical Co., Ltd., product name: sodium glutamate RC) 0.1 parts by mass
Spice (pepper) 0.1 parts by mass
Water 60 parts by mass

Sixty grams of the obtained blend was formed into a patty having a diameter of 80 mm and a depth of 10 mm.

Next, the obtained patty was heated and cooked (baked) for 4 minutes on each side in a frying pan (outer diameter 280 mm) on an IH cooker to obtain a meatless hamburger patty (Sample 4).

### Comparative Example 15

A meatless hamburger patty (Sample 5) was obtained in the same manner as in Example 9, except that the meat-like protein composition obtained in Comparative Example 1 of Experiment 1 was used instead of the meat-like protein composition obtained in Example 6 of Experiment 3.

### Comparative Example 16

A meatless hamburger patty (Sample 6) was obtained in the same manner as in Example 9, except that granular soy protein (manufactured by FUJI OIL CO., LTD., product name: New Fujinic 52S) was used instead of the meat-like protein composition obtained in Example 6 of Experiment 1.

In the same manner as in Experiment 3, the texture and flavor of the meatless hamburger patties (Samples 4 to 6) obtained in Example 9 and Comparative Examples 15 and 16 were evaluated, and the results thus obtained were comprehensively evaluated.

The obtained results are shown in Table 5 together with the ingredients of the meat-like protein compositions for the meatless hamburger patty.

TABLE 5

| | | Meatless Hamburger patty | | | | |
|---|---|---|---|---|---|---|
| | | Meat-like Protein Composition | | | | |
| | | | Blended | Score/Evaluation | | |
| | | | Amount | | | Comprehensive |
| | | Material | (parts by mass) | Texture | Flavor | Evaluation |
| Example 9 | Sample 4 | Meat-like Protein Composition of Example 6 | 97.1 | 3.6 | 3.2 | ∘ |
| Comparative Example 15 | Sample 5 | Meat-like Protein Composition of Comparative Example 1 | | 2.3 | 2.8 | x |
| Comparative Example 16 | Sample 6 | Granular Soy Protein | | 1.6 | 1.3 | x |

From the results shown in Table 5, it can be seen that the meatless hamburger patty (Sample 4) prepared using the meat-like protein composition obtained in Example 6 of Experiment 3 had a very strong granular feeling, was juicy, had good chewiness, and had less plant protein odor, as compared with the meatless hamburger patty (Sample 5) prepared using the meat-like protein composition obtained in Comparative Example 1 of Experiment 1 and the meatless hamburger patty (Sample 6) prepared using the granular soy protein.

From the results of Tables 2 to 5, it is found that the food product meat-like protein composition having a good flavor, an excellent ease of seasoning, juiciness, and an excellent meat-like texture can be obtained by adding, to a gluten, in particular wheat gluten, a dietary fiber derived from wheat grain and a protein derived from wheat grain other than gluten, in particular a dietary fiber and a protein derived from a main product or a by-product of the process for producing wheat protein or wheat flour starch.

In addition, the meat-like protein composition of the present invention may be obtained in a dry form, which is ready to be reconstituted with water, does not require freezing storage, unlike conventional meat-like protein compositions, and has excellent storage stability.

What is claimed is:

1. A meat-like protein composition comprising:
a gluten, and with respect to 100 parts by mass of the gluten,
0.2 to 3 parts by mass of a dietary fiber derived from wheat grain, and
0.08 to 0.7 parts by mass of a protein, other than the gluten, derived from wheat grain.

2. The meat-like protein composition according to claim 1, wherein the protein is at least one selected from the group consisting of gliadin, glutenin, albumin and globulin, all of which are derived from wheat.

3. The meat-like protein composition according to claim 1, wherein the gluten is wheat gluten.

4. The meat-like protein composition according to claim 1, wherein the dietary fiber and the protein are derived from a main product or a by-product of a process for producing wheat protein or wheat flour starch.

5. The meat-like protein composition according to claim 1, wherein the dietary fiber and the protein are derived from an “aka-kasu” residue, a “shiro-kasu” residue, or wheat flour starch.

6. (canceled)

7. A method for producing a meat-like protein composition, the method comprising a step of mixing a gluten with 0.2 to 3 parts by mass of a dietary fiber derived from wheat grain and 0.08 to 0.7 parts by mass of a protein, other than the gluten, derived from wheat grain, with respect to 100 parts by mass of the gluten.

8. (canceled)

9. A meat-like food product comprising the meat-like protein composition according to claim 1.

10. The method for producing a meat-like protein composition according to claim 7, wherein, in the step of mixing, the dietary fiber and the protein are added as a composition comprising the dietary fiber and the protein at a mass ratio of 0.2 to 3:0.08 to 0.7.

11. The method for producing a meat-like protein composition according to claim 7, wherein the protein is at least one selected from the group consisting of gliadin, glutenin, albumin and globulin, all of which are derived from wheat.

12. The method for producing a meat-like protein composition according to claim 7, wherein the gluten is wheat gluten.

13. The method for producing a meat-like protein composition according to claim 7, wherein the dietary fiber and the protein are derived from a main product or a by-product of a process for producing wheat protein or wheat flour starch.

14. The method for producing a meat-like protein composition according to claim 7, wherein the dietary fiber and the protein are derived from an “aka-kasu” residue, a “shiro-kasu” residue, or wheat flour starch.

15. (canceled)

16. The meat-like protein composition according to claim 1, the composition having a water absorption capacity of 300 to 400% of the dry mass.

17. The meat-like protein composition according to claim 1, the composition being in a dry form.

18. The meat-like protein composition according to claim 1, the composition further comprising a hydrolyte of wheat flour starch.

19. The meat-like protein composition according to claim 1, the composition being in a granular shape.

20. The method for producing a meat-like protein composition according to claim 7, the method further comprising a step of heating and coagulating the mixture obtained in the step of mixing and an optional step of drying the heated and coagulated mixture.

21. A method for improving a texture of a meat-like protein composition comprising a gluten, the method comprising a step of mixing the meat-like protein composition with 0.2 to 3 parts by mass of a dietary fiber derived from wheat grain and 0.08 to 0.7 parts by mass of a protein, other than the gluten, derived from wheat grain, with respect to 100 parts by mass of the gluten.

22. The meat-like protein composition according to claim 1,
the composition comprising the gluten and at least one additive composition selected from the group consisting of an “aka-kasu” residue, a “shiro-kasu” residue and wheat flour starch, and having a water absorption capacity of 300 to 400% of the dry mass,
wherein the additive composition comprises 0.2 to 3 parts by mass of a dietary fiber derived from wheat grain, and 0.08 to 0.7 parts by mass of a protein, other than the gluten, derived from wheat grain, with respect to 100 parts by mass of the gluten.

23. The method for producing a meat-like protein composition according to claim 7, the method comprising a step of mixing a gluten with at least one additive composition selected from the group consisting of an “aka-kasu” residue, a “shiro-kasu” residue and wheat flour starch,
wherein the additive composition comprises, 0.2 to 3 parts by mass of a dietary fiber derived from wheat grain, and 0.08 to 0.7 parts by mass of a protein, other than the gluten, derived from wheat grain, with respect to 100 parts by mass of the gluten.
